(19) United States
(12) Patent Application Publication
(10) Pub. No.: US 2012/0040850 A1
(43) Pub. Date: Feb. 16, 2012

(54) Methods for Diagnosis and Assessment of Autoimmune Disorders

(76) Inventor: Mark Kopnitsky, Lenhartsville, PA (US)

(21) Appl. No.: 13/062,692

(22) PCT Filed: Sep. 9, 2009
(86) PCT No.: PCT/US09/56307

§ 371 Date: Oct. 31, 2011

Related U.S. Application Data
(60) Provisional application No. 61/095,613, filed on Sep. 9, 2008.

(51) Int. Cl. C40B 30/04

(52) U.S. Cl. 506/9

(57) ABSTRACT

The present invention relates to methods and compositions for use in the diagnosis, assessment and treatment of patients with suspected autoimmune disorders. In particular, the present invention provides an auto-antibody assessment system that combines a multiplex bead array using purified antigens with human cells. When analysis is performed with the system using means such as flow cytometry, this mixture can provide a more comprehensive auto-antigen profile for assessing disease states in autoimmune disorders.

### BACKGROUND OF THE INVENTION

1. Field of the Invention

Generally, the present invention relates to the field of diagnosing and assessing autoimmune disorders, and more specifically novel methods for the use of multiplex bead array analyzers in auto-antibody diagnostic assays.

2. Background Art

Antibodies are proteins produced by the body in response to invading or infectious materials. They constitute one of the many means the body has to protect itself from disease. In normal circumstances, the body can recognize “foreign” from “self” tissues, and therefore only generates antibodies to those materials that are “foreign” to the body.

Autoimmunity develops when the body begins to produce antibodies to its own tissues. There are numerous types of autoimmune disorders; some systemic and others that are organ specific. The exact mechanism that initiates these diseases is not fully understood. Some may be easily treated with minimal patient impact while others can be quite severe and even fatal.

The symptoms associated with the onset of an autoimmune disorder can be varied. Also, any of the early symptoms can mimic those of many other diseases. Typically, if a patient visits a physician with symptoms remotely suggestive of an autoimmune disorder, the physician will usually suggest that an anti-nuclear antibody (ANA) test be performed. The ANA test is a good “first round” screening test to see if somebody has antibody to self tissues. There are many different versions of the ANA Screen test. Methodologies can range from western blot to microparticle arrays; however, the most popular is probably the fluorescent anti-nuclear antibody assay (FANA).

At the present time, the most popular of the commercially available FANA tests is the so-called HEp-2 FANA test. HEp-2 is a continuous, human epithelial cell line that grows rapidly and readily attaches to solid surfaces such as tissue culture flasks and glass slides. The HEp-2 cell also has a large, well defined nucleus. The HEp-2 FANA test is made by growing HEp-2 cells on glass slides and fixing the cells permanently on the surface of the slide. The assay is performed by allowing a serum sample from a patient to react to the cells. If anti-nuclear antibodies are present, they will bind to the cells. The slides are washed and the antibody is labeled with anti-human Immunoglobulin (Ig) labeled with a fluorescent tag. When viewed using a properly equipped microscope, specific patterns of reactivity are observed which are associated with specific autoimmune disorders. Examples of these patterns are shown in FIG. 1.

Auto-antigens, used in the ANA test, represent the majority, but not all, of known auto-antigens expressed on the HEp-2 cell. Some auto-antigens found on the HEp-2 cell are not present in the multiplex suspension. Consequently, the multiplex bead method, such as the AtheNA Multi-Lyte ANA Test System (commercially available from Zeus Scientific, Inc., Bridgewater, N.J.), contains a bead mix that is built on the Luminex xMAP® platform (Luminex Corporation, Austin, Tex.) using only a highly purified auto-antigen mixture conjugated onto separate microspheres and run as a multiplex assay. This system has most, but not all, of the auto-antigens found on the HEp-2 cell. For that reason, it would be desirable to include an actual HEp-2 cell along with the multiplex bead mix to ensure that the patient sample is tested for all potential autoantigens substantially simultaneously (all known and yet unknown autoantigens).

While the HEp-2 FANA method has become the reference method, the aforementioned AtheNA Multi-Lyte ANA Test System provides substantially equivalent results. However, it would be greatly advantageous to combine the features associated with a conventional FANA test and those of the multiplex bead mix into a single assay.

### SUMMARY OF THE INVENTION

In contrast to the conventional methodologies previously known, it is an object of the present invention to provide a novel method that combines the features associated with a conventional FANA test and those of the multiplex bead mix into a single assay, to provide physicians and other users of the method with previously unknown advantages for the diagnosis and assessment of autoimmune disorders, such as ease of use and enhanced assay speed. In accordance with the invention, these advantages are unexpectedly achieved from a combination of substantially simultaneous performance of a HEp-2 FANA method and the comprehensive auto-antigen analysis provided by a multiplex bead system.

In addition, it is another object of the present invention to provide a method for obtaining a sample from a subject suspected of having an autoimmune disorder and assessing the auto-antibody activity of the subject, which method comprises the steps of:
a. obtaining a sample from a subject suspected of having an autoimmune disorder;
b. reacting the sample with auto-antigens linked to a mixed population of beads or microparticles;
c. substantially simultaneously reacting the resulting mixture of said beads and said sample with surface-fixed cells; and
d. analyzing the antigen-antibody reaction profile obtained from the steps a. through c., thereby to diagnose or assess the auto-antibody activity of the subject.

Further, it is still another object of the present invention to provide a method for obtaining a sample from a subject suspected of having a disorder caused by an infectious agent that is cellular in nature (bacterial, viral, or the like) and assessing the antibody activity of the subject, which method comprises the steps of:
a. reacting the sample with appropriate infectious disease antigens linked to a mixed population of beads or microparticles;
b. substantially simultaneously reacting the resulting mixture of said beads and said sample with cells containing the infectious agent; and
c. analyzing the antigen-antibody reaction profile obtained from the preceding steps, thereby to diagnose or assess the antibody activity of the subject.
   Other objects, features and advantages of the present invention will become apparent to those skilled in the art from the following detailed description.

### BRIEF DESCRIPTION OF THE DRAWING

FIG. 1 shows examples of positive ANA reactions; specific patterns of reactivity are shown using HEp-2 FANA (performed using a conventional slide method).

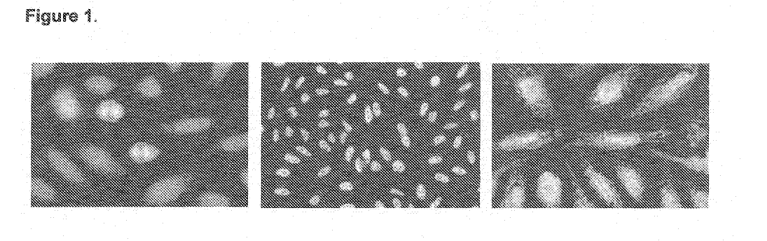

### DETAILED DESCRIPTION OF THE INVENTION

In contrast to the conventional methodologies previously known, it is an object of the present invention to provide a novel method that combines the features associated with a conventional FANA assay system and those of an assay system using a multiplex bead mix into a single assay, to provide physicians and other users of the method with previously unknown advantages such as ease of use and enhanced assay speed, as well as providing the unexpectedly advantageous results that derive from a combination of the performance of a HEp-2 FANA method and the performance of a comprehensive auto-antigen analysis as provided by a multiplex bead system, thereby to provide an improved assay system for the diagnosis and assessment of autoimmune disorders.

Accordingly, the present invention, in preferred embodiments, provides methods for the substantially simultaneous analysis of autoantigens in a single sample from a subject using a combination of traditional particles such as microspheres, for example commercially available Luminex microspheres, and a HEp-2 cells FANA assay.

The term “multiplex bead array platform” as used herein refers to any platform that utilizes particles or micro-particles that are distinguishable. Such distinguishable particles may be utilized, for example, to conduct multiplex immunoassays or molecular probe based assays. A popular example of a widely used multiplex bead array platform is the system developed and commercially available based on the Luminex® xMAP® Technology (Luminex Corporation, Austin, Tex.). The term “classification dyes” as used herein refers to any mixture or combination of microparticles or beads used in the multiplex assay that have a mixture of classification dyes that enable the instrument to sort and classify the particles. The term “reporter molecule” includes, without limitation, any and all fluorescent tags that are bound to the detection molecule in the assay. In the case of immunoassays designed to measure human antibody, the detection molecule can, for example, be goat anti-human IgG that is labeled with phycoerythrin.

The present invention, in one preferred embodiment, therefore combines a FANA test and a multiplex bead mix into a single, conveniently performed assay. A conventional HEp-2 FANA test is a slide test using HEp-2 cells that have been allowed to grow in tissue culture media on the surface of the glass slide. They are thereafter rinsed and fixed with organic solvents. This increases the permeability of the membrane and keeps them adherent onto the glass slide. The combination assay of the present invention can be performed on, for example, a Luminex xMAP instrument, which is essentially a flow cytometer that has been modified for use of the Luminex polystyrene microspheres in a multiplex bead assay. However, flow cytometry is an imaging technology that is capable of analyzing cells for cellular characteristics or cell counting, so that when this technique is combined with the multiplex bead array, it is capable of providing a more comprehensive sample analysis.

In an example of the practice of one preferred embodiment of the present invention, HEp-2 cells are grown in tissue culture media in flasks. The cells are harvested and washed to remove components of the media. The cells are then re-suspended and fixed in solution, preserving the morphologic, biologic, and antigenic integrity of the cells. Simultaneous with the fixation, both the cellular and nuclear membranes of the cells are permeabilized. The fixed cells are then mixed with the multiplex bead suspension from the AtheNA ANA test, and all of the beads and the fixed cells are then used to analyze a serum sample from a patient.

It will be appreciated that in addition to analysis of serum samples as described above, the methods and teachings of the present invention can be applied to analysis of any biological fluid that may be obtained from a subject; for example, blood, urine, cerebral spinal fluid and plasma can all be suitable for obtaining samples upon which to perform the methods of analysis in accordance with the present invention.

The size gate of the above-described Luminex instrument, and the classification gate of the Luminex instrument utilized, in performance of assays provided by the present invention, can each be modified in accordance therewith in manners that will be well known and appreciated by those skilled in the art, to detect both the Luminex microspheres and the HEp-2 cells. In this way, according to the present invention a single test system is capable of utilizing the multiplex bead suspension employing the highly purified, well characterized auto-antigens, as well as substantially simultaneously performing the traditional FANA assay on fixed HEp2-cells, to obtain results that provide a substantially more comprehensive autoantigen profile than has been capable of being provided by largely conventional assay systems of the previous art.

The optical detection system employed in the assay system of the present invention typically will comprise a laser, as is typically employed with most multiplex bead array analyzers, which is used to measure the amount of reporter molecule bound to the surface of the particle. In some preferred embodiments of assay systems of the present invention there may be more than one laser used for this function. In some other preferred embodiments of assay systems of the invention there may be only one laser used for this function. The number of lasers available for this function dictates the number of reporter molecules that may be measured and differentiated from one another. In the case of the example Luminex® system, there is only one laser (green laser) available for measurement of the reporter molecule, and therefore only one reporter molecule may be measured at a time. It is to be appreciated, however, that the present invention contemplates all combinations of lasers that could be used in detecting the amount of reporter molecule bound to the surface of the particle, and that such combinations will be readily apparent to those skilled in the art. In addition, those skilled in the art will appreciate that other similar systems may utilize LCDs and CCD cameras, or similar components, to accomplish the same outcome (excitation of fluorophores at various wavelengths and measurement of the resulting emissions), and that all of the foregoing are within the scope of the invention as described herein.

Accordingly, the present invention advantageously provides a single assay system that incorporates, in part, an FANA assay together with a multiplex bead mix assay, in order to achieve an assay system which will provide the the unexpected results as described herein. Thus, in a single sample from a subject such as a patient suspected of having an autoimmune disorder, particles such as coated beads or microspheres can be used to detect very specific antibodies or antigens, and at the same time measurement of antibody activity to human cells, such as the HEp-2 cell, can be made, to diagnose or assess the auto-antibody activity of the subject.

Specifically, it has been found that an advantageous assay system of the invention can be produced by allowing the HEp-2 cells to grow on the surface of a 96 well microtiter plate (such a surface, however, can be for example, any vessel including a slide), and fixing the cells to the plate, then using the plate to dispense the coated beads or microspheres and running the assay. After the instrument completes the analysis of the beads from the well, the same plate is placed on either a fluorescent reader or a microscope, and the results from the cells are interpreted. In this case the cells are not in suspension with the beads, but help to make up the reaction vessel that the assay of the beads is performed in.

In the practice of the present invention, the ability provided by the novel methods of the invention described herein, to detect multiple analytes in one reaction mixture and substantially simultaneously, has been found unexpectedly to substantially reduce or eliminate the variability often seen in results arising from the performance of separate assays. In the multiplex bead mix, particles such as beads are coated with specific auto-antigens, known to be expressed in HEp-2 cells and associated with specific autoimmune disorders. In this way, those patients that may possess extremely rare or infrequently occurring autoantibodies, that otherwise would go undetected using the microparticle assay alone, can be detected as reactive to the HEp-2 cell, thereby alerting the physician to investigate and to make decisions with respect to the necessity of performing additional autoantibody analyses.

Further, it is to be appreciated that many additional modifications and variations, that will be apparent to those skilled in the art in view of the disclosure herein, may be made in the specific embodiments of the invention as described herein, and that all such modifications are fully within the scope of the present invention.

One example of such a modification to the methods and procedures in accordance with the invention as described above, and that is within the scope of the present invention, would be to place fixed, that is, permeabilized HEp-2 cells on the surface of the reaction vessel used to house the multiplex bead mixture. In this method, both the multiplex bead mixture and the HEp-2 cells are exposed to all assay reactants and conditions. At the end of the assay, the beads may be analyzed via the multiplex bead reader (for example by means of the Luminex instrument described previously) and the cells could, subsequently be analyzed via a separate fluorescent reader or microscope. In this embodiment of the invention, the desired outcome is still achieved: a substantially simultaneous assay is enabled incorporating specific autoantigens on the surface of multiplex beads, and cellular analysis is also enabled under the same assay conditions and at substantially the same.

Another example of such a modification to the specific methods and procedures in accordance with the present invention as described herein, is the advantageous ability of the invention to provide, in addition to the foregoing, methods for obtaining a sample from a subject suspected of having an autoimmune disorder and assessing the auto-antibody activity of the subject. Such a method comprises the steps of reacting such a sample with auto-antigens linked to a mixed population of beads or microparticles; substantially simultaneously reacting the resulting mixture of said beads and said sample with surface-fixed cells; and analyzing the antigen-antibody reaction profile obtained from the preceding steps, thereby to diagnose or assess the auto-antibody activity of the subject.

A still further example of a modification to the specific methods and procedures in accordance with the present invention as described herein is the advantageous ability of the invention to provide a method for obtaining a sample from a subject suspected of having a disorder caused by an infectious agent that is cellular in nature (bacterial, viral, or the like), and assessing the antibody activity of the subject. Such a method comprises the steps of reacting the sample with appropriate infectious disease antigens linked to a mixed population of beads or microparticles; substantially simultaneously reacting the resulting mixture of said beads and said sample with cells containing the infectious agent; and analyzing the antigen-antibody reaction profile obtained from the preceding steps, thereby to diagnose or assess the antibody activity of the subject.

For example, in the practice of the present invention for the analysis of a sample from a subject suspected of having a disorder caused by an infectious agent, for example Lyme disease, specific, highly purified Borrelia antigens are placed onto separate beads, and the beads are then mixed with actual fixed Borrelia bacteria, in accordance with the procedures previously described. The instrument used in the analysis can then analyze both the beads and the bacteria, substantially simultaneously, for the presence of antibody reactions. This procedure can also be applied in accordance with the teachings of the invention for the analysis of various bacteria, intracellular parasites, virally infected cell lines and the like.

Accordingly, it is to be appreciated that while certain aspects of the preferred embodiments of the present invention have been described, it is not intended that the invention be limited to such embodiments. Various modifications may be made thereto without departing from the spirit of the present invention, the full scope of which is delineated solely in the following claims.

What is claimed is:

1. A method for diagnosing or assessing auto-antibody activity in a subject, which method comprises:
a. obtaining a sample from a subject suspected of having an autoimmune disorder;
b. reacting the sample with auto-antigens linked to a mixed population of beads or microparticles;
c. substantially simultaneously reacting the mixture resulting from step b with solution-fixed cells; and
d. analyzing the antigen-antibody reaction profile obtained from steps a through c, thereby to diagnose or assess the auto-antibody activity of the subject.

2. A method for obtaining a sample from a subject suspected of having an autoimmune disorder and diagnosing or assessing the auto-antibody activity of the subject, which method comprises reacting the sample with auto-antigens linked to a mixed population of beads or microparticles; substantially simultaneously reacting the resulting mixture with surface-fixed cells; and analyzing the antigen-antibody reaction profile obtained from the preceding steps, thereby to diagnose or assess the auto-antibody activity of the subject.

3. A method for obtaining a sample from a subject suspected of having an disorder caused by an infectious agent that is cellular in nature and diagnosing or assessing the antibody activity of the subject, which method comprises reacting the sample with appropriate infectious disease antigens linked to a mixed population of beads or microparticles; substantially simultaneously reacting the resulting mixture with cells containing the actual infectious agent; and analyzing the antigen-antibody reaction profile obtained from the preceding steps, thereby to diagnose or assess the antibody activity of the subject.

4. The method according to any one of claim 1, 2 or 3, wherein the sample is a serum sample.

5. The method according to any one of claim 1, 2 or 3, wherein the sample is selected from the group of biological fluids consisting of blood, urine, cerebral spinal fluid or plasma.

6. A method for diagnosis and assessment of an autoimmune disorder in a patient suspected of having the disorder, which method comprises the steps of obtaining a sample from a subject suspected of having an autoimmune disorder; reacting the sample with auto-antigens linked to a mixed population of beads or microparticles; substantially simultaneously reacting the mixture resulting from the preceding step with solution-fixed cells; and analyzing the antigen-antibody reaction profile obtained from the preceding steps, thereby to diagnose or assess the auto-antibody activity of the subject.
